(19) United States
(12) Patent Application Publication
(10) Pub. No.: US 2026/0199171 A1
(43) Pub. Date: Jul. 16, 2026

(54) THREE-DEGREE-OF-FREEDOM WEARABLE UPPER LIMB REHABILITATION EXOSKELETON MECHANISM

(71) Applicant: Nanchang University, Nanchang (CN)

(72) Inventors: Zhiwei MAO, Nanchang (CN); Wei ZHANG, Nanchang (CN); Shufeng WANG, Nanchang (CN); Wenjun LI, Nanchang (CN); Lixu LIU, Nanchang (CN)

(21) Appl. No.: 19/322,158

(22) Filed: Sep. 8, 2025

(30) Foreign Application Priority Data
Jan. 13, 2025 (CN) 202510050709.0

(51) Int. Cl. A61H 1/02

(52) U.S. Cl. CPC A61H 1/0277; A61H 1/0281; A61H 2201/1638; A61H 2201/165; A61H 2201/1676

(57) ABSTRACT

The present invention relates to the technical field of medical rehabilitation and discloses a three-degree-of-freedom wearable upper limb rehabilitation exoskeleton mechanism, including: a shoulder joint mechanism and an elbow joint mechanism. Two ends of the shoulder joint mechanism are fastened to a human shoulder and a human upper arm, respectively, and the shoulder joint mechanism is configured to drive the human upper arm to implement flexion, extension, abduction, and adduction movements. Two ends of the elbow joint mechanism are fastened to the human upper arm and a human forearm, respectively, and the elbow joint mechanism is configured to drive the human forearm to implement flexion and extension movements.

### CROSS-REFERENCE TO RELATED APPLICATIONS

The present application claims priority to Chinese patent application No. 202510050709.0, entitled “THREE-DEGREE-OF-FREEDOM WEARABLE UPPER LIMB REHABILITATION EXOSKELETON MECHANISM” filed on January 13, 2025, the entire contents of which are incorporated herein by reference.

### FIELD OF TECHNOLOGY

The present invention relates to the technical field of medical rehabilitation, and in particular to a three-degree-of-freedom wearable upper limb rehabilitation exoskeleton mechanism.

### BACKGROUND

The prevalence of stroke among people aged 40 and above in China increased from 1.89% in 2022 to 2.19% in 2023. The rate of increase in stroke mortality is much higher than that in other countries worldwide, and stroke has become a leading cause of death among Chinese residents. According to population survey data released by the National Bureau of Statistics in 2022, the current population of people aged 65 and above in China has exceeded 200 million, and by 2050 this proportion is expected to be 11.14% higher than the global average. With the continuing aggravation of the population aging, the risks of diseases such as stroke and spinal cord injury that impair patients' limb motor functions have significantly increased, creating major challenges for elderly care, nursing, and rehabilitation. Upper limb rehabilitation robots, which integrate mechanisms of central nervous system plasticity with robotic systems, can independently implement or assist in rehabilitation training and functional assessment for patients with limb motor dysfunction. Such robots provide better autonomy for patients, and improving the life quality for disabled patients and the elderly.

At present, upper limb exoskeleton robots mainly fall into two categories: rigid and soft upper limb exoskeleton robots. Rigid upper limb exoskeleton robot suffer from drawbacks such as poor motion compatibility, limited workspace, mechanical singularities, excessive weight, discomfort, and misalignment. Soft upper limb exoskeleton robots, on the other hand, have disadvantages such as lower assistive driving power compared to the rigid robots, an inability to fully replace patients’ joint motor functions, and some requirements for the patients' residual motor ability. In addition, both rigid and soft upper limb exoskeleton robots are burdened by relatively heavy driving devices, making them less suitable for wearing.

### SUMMARY

The present invention is intended to overcome at least one of the above-mentioned problems in the prior art.

To achieve the foregoing objective, the present invention provides a three-degree-of-freedom wearable upper limb rehabilitation exoskeleton mechanism, including: a shoulder joint mechanism and an elbow joint mechanism, where two ends of the shoulder joint mechanism are fastened to a human shoulder and a human upper arm, respectively, and the shoulder joint mechanism is configured to drive the human upper arm to implement flexion, extension, abduction, and adduction movements; and two ends of the elbow joint mechanism are fastened to the human upper arm and a human forearm, respectively, and the elbow joint mechanism is configured to drive the human forearm to implement flexion and extension movements,

where the shoulder joint mechanism includes: a shoulder fastening member connected to the human shoulder through a first fastening pair; a first member connected to the shoulder fastening member through a first revolute pair; a second member connected to the first member through a second revolute pair and a fourth revolute pair, axes of the second revolute pair and the fourth revolute pair being coaxially arranged; a third member connected to the second member through a third revolute pair, where revolute axes of the first revolute pair, the second revolute pair, and the third revolute pair are mutually orthogonal; a fourth member connected to the third member through an arc groove, a revolute center of the arc groove being located on a side of the third member close to the human upper arm; a fifth member connected to the fourth member through a first cylindrical pair; an eighth member connected to the fifth member through a sixth revolute pair, an axis of the first cylindrical pair being orthogonal to a revolute axis of the sixth revolute pair, and the eighth member being connected to the human upper arm through a second fastening pair; and

the elbow joint mechanism includes: the eighth member connected to the human upper arm through the second fastening pair; a sixth member connected to the eighth member through a fifth revolute pair; a seventh member connected to the sixth member through a second cylindrical pair; a ninth member connected to the seventh member through a seventh revolute pair, an axis of the second cylindrical pair being orthogonal to a revolute axis of the seventh revolute pair, and the ninth member being connected to the human forearm through a third fastening pair.

In some embodiments, the eighth member and the human upper arm are vertically fastened to each other through the second fastening pair.

In some embodiments, an axis of the fifth revolute pair and an axis of the first cylindrical pair are perpendicular to each other.

In some embodiments, the ninth member and the human forearm are perpendicularly fastened to each other through the third fastening pair.

In the above technical solutions, the three-degree-of-freedom wearable upper limb rehabilitation exoskeleton mechanism of the present invention has the following beneficial effects.

The flexion, extension, abduction, and adduction of the human upper arm are implemented through the shoulder joint mechanism, while the flexion and extension of the human forearm are implemented through the elbow joint mechanism. Further, movements of the human upper arm and the human forearm are combined, so that a hand can be moved to a desired position. The upper limb rehabilitation exoskeleton mechanism provided by the present invention has simple motion relationships that are easy to implement, requires fewer driving units, and improves movement precision.

A quantity of members in the upper limb rehabilitation exoskeleton mechanism is relatively small, making the exoskeleton device lightweight.

When the upper limb rehabilitation exoskeleton mechanism is worn, alignment with the human joints is not required. This design resolves the problem of joint misalignment during use, reduces the precision requirements for connecting the mechanism’s members to the human body, and therefore makes the mechanism easier to wear.

When the upper limb rehabilitation exoskeleton mechanism provided by the present invention drives rehabilitation movements of the shoulder joints and elbow joints, the non-driving force or torque exerted on the human joints in the human-machine closed-chain mechanism enhances patient comfort and prevents joint damage during rehabilitation exercises.

The upper limb rehabilitation exoskeleton mechanism of the present invention can be applied to patients in different sizes. When upper limb sizes of different patients change, the first cylindrical pair and the fourth member, and/or the second cylindrical pair and the sixth member are adjusted, so that relative positions of the sixth member and the seventh member can be automatically adjusted, thus implementing adaptive wearing for different patients with variations in upper limb sizes, thereby helping to wear the upper limb exoskeleton mechanism and reducing specifications or models of the upper limb exoskeleton.

### BRIEF DESCRIPTION OF THE DRAWINGS

FIG. 1 is a schematic diagram of an upper limb exoskeleton mechanism according to the present invention;

FIG. 2 is a schematic diagram of a shoulder joint mechanism according to the present invention;

FIG. 3 is a schematic diagram of an elbow joint mechanism according to the present invention; and

FIG. 4 is a schematic diagram of an upper limb exoskeleton assembly according to the present invention.

### DESCRIPTION OF THE EMBODIMENTS

The following provides a detailed description of specific implementations of the present invention with reference to the accompanying drawings. It should be understood that the specific implementations described herein are provided solely for the purpose of illustration and explanation, and are not intended to limit the scope of the present invention.

In the present invention, unless otherwise specified, terms "upper", "lower", "left", "right", "inner", "outer", "top", "bottom" and similar terms indicating orientation or positional relationships are based on orientation or positional relationships shown in the drawings, and are only for the purpose of demonstration, but not to indicate or imply that indicated devices or elements must have specific orientations, be constructed and operated in specific orientations, and therefore should not be construed as a limitation of the present invention.

In addition, the terms "first", "second", and the like are used only for descriptive purposes and should not be construed as indicating or implying relative importance or implicitly indicating a quantity of indicated technical features. Thus, features defined as "first" or "second" may explicitly or implicitly include at least one such feature. In the description of the present invention, "a plurality of" means at least two, for example, two, three, or the like, unless otherwise specifically defined.

In the description of the present invention, descriptions with reference to the term such as "one embodiment", "some embodiments", "exemplary embodiment", "specific example", or "some examples" mean that a particular feature, structure, material, or characteristic described with reference to the embodiment or example are included in at least one embodiment or example of the present invention. The illustrative use of these terms do not necessarily mean a same embodiment or example. Moreover, the specific feature, structure, material, or characteristic described may be combined in any suitable manner in any one or more embodiments or examples. In addition, those skilled in the art may combine and group different embodiments or examples described in this specification, as well as the features of different embodiments or examples, without conflicting with each other.

In the present invention, unless expressly stipulated and defined otherwise, the terms "install", " join", "connect", "fasten" should be understood in a broad sense. For example, "connection" may be a firm connection, a detachable connection, or an integral connection; may be a mechanical connection, or may be an electrical connection or communication with each other; or may be a direct connection, an indirect connection by means of an intermediate medium, or a connection between two elements or an interaction between two elements, unless expressly defined. Those skilled in the art can understand specific meanings of these terms in the present invention based on specific situations.

Upper limb exoskeleton robots, such as robotic arms, can independently implement or assist in rehabilitation training and assessment for limb motor dysfunction by matching the movement of human upper limbs, thereby providing great autonomy for people with limb motor dysfunction. Existing upper limb exoskeleton robots mainly include two categories: rigid upper limb exoskeleton robots and soft exoskeleton robots. The rigid upper limb exoskeleton robot mechanisms have defects such as motion compatibility, workspace limitations, mechanical system singularities, heavy weight, discomfort, and misalignment. The soft upper limb exoskeleton robots have disadvantages such as lower assistive driving power compared to the rigid robots, inability to fully replace a joint motor function of patients, and some requirements for the patients' own motor ability. In addition, Chinese Patent CN106393071B discloses a nine-degree-of-freedom wearable adaptive upper limb rehabilitation exoskeleton mechanism. Although a plurality of passive degrees of freedom are added to a shoulder joint to compensate for axis drift during the movement of a glenohumeral joint, a robot kinematic pair of this exoskeleton robot still needs to be aligned with a human joint when worn. Moreover, a large quantity of members results in a heavy robot, and a large quantity of degrees of freedom leads to a large quantity of drive motors and complex motion control.

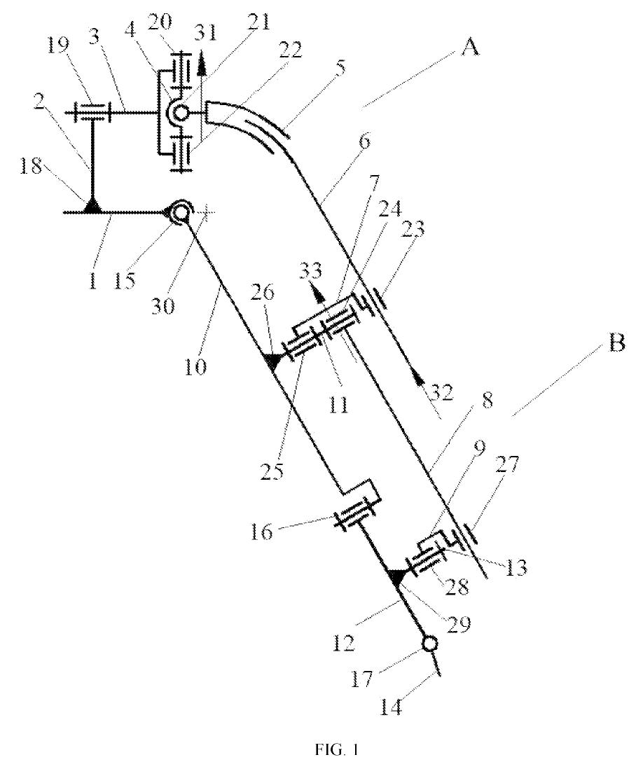

The present invention provides a three-degree-of-freedom wearable upper limb rehabilitation exoskeleton mechanism to mainly address problems of inconvenient wearing and complex motion control of upper limb exoskeleton robots in the prior art. As shown in FIG. 1 to FIG. 3, the upper limb rehabilitation exoskeleton mechanism includes a shoulder joint mechanism A and an elbow joint mechanism B. Two ends of the shoulder joint mechanism A are fastened to a human shoulder 1 and a human upper arm 10, respectively. The shoulder joint mechanism A is configured to drive the human upper arm 10 to implement flexion, extension, abduction, and adduction movements around the shoulder joint kinematic pair 15, thereby implementing rehabilitation training for a human shoulder joint. Two ends of the elbow joint mechanism B are fastened to the human upper arm 10 and a human forearm 12, respectively. The elbow joint mechanism B is configured to drive the human forearm 12 to implement flexion and extension movements around an elbow joint kinematic pair 16, thereby implementing rehabilitation training for a human elbow joint.

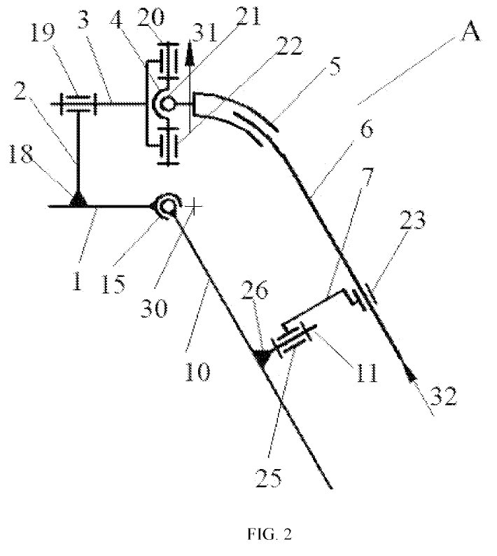

As shown in FIG. 1 and FIG. 2, the shoulder joint mechanism A includes: a first fastening pair 18, a shoulder fastening member 2, a first member 3, a second member 4, a third member 5, a fourth member 6, a fifth member 7, an eighth member 11, a first revolute pair 19, a second revolute pair 20, a third revolute pair 21, a fourth revolute pair 22, a first cylindrical pair 23, a sixth revolute pair 25, and a second fixing pair 26. The shoulder fastening member 2 is connected to the human shoulder 1 through the first fastening pair 18. The shoulder fastening member 2 is connected to the first member 3 through the first revolute pair 19. The first member 3 is connected to the second member 4 through the second revolute pair 20 and the fourth revolute pair 22. Revolute axes of the second revolute pair 20 and the fourth revolute pair 22 are coaxially arranged. The second member 4 is connected to the third member 5 through the third revolute pair 21. Three revolute axes formed by the first revolute pair 19, the second revolute pair 20, the third revolute pair 21, and the fourth revolute pair 22 are mutually orthogonal in pairs. Therefore, the first revolute pair 19, the second revolute pair 20, the third revolute pair 21, and the fourth revolute pair 22 can be equivalent to spherical pairs. The third member 5 is connected to the fourth member 6 through an arc groove, and a revolute center 30 of the arc groove is located on a side of the arc groove close to the human upper arm 10. The fourth member 6 is connected to the fifth member 7 through the first cylindrical pair 23. The fifth member 7 is connected to the eighth member 11 through the sixth revolute pair 25. A revolute axis of the sixth revolute pair 25 is orthogonal to an axis of the first cylindrical pair 23. The eighth member 11 is connected to the human upper arm 10 through the second fastening pair 26.

The shoulder joint mechanism A provided by the present invention can be connected to the human shoulder 1 through the shoulder fastening member 2 by means of the first fastening pair 18, and to the human upper arm 10 through the eighth member 11 by means of the second fastening pair 26. In this way, movement of the shoulder joint mechanism A drives the human upper arm 10 to perform a corresponding movement around the shoulder joint kinematic pair 15.

In the shoulder joint mechanism A provided by the present invention, in combination with a physiological structure and movement characteristics of the human shoulder joint, three orthogonal revolute pairs (the first revolute pair 19, the second revolute pair 20, the fourth revolute pair 22, and the third revolute pair 21) that are equivalent to spherical pairs, a guide groove equivalent to a revolute pair, and a composite kinematic pair formed by the first cylindrical pair 23 and the sixth revolute pair 25 form a spatial swing link mechanism with the shoulder joint kinematic pair 15. This spatial swing link mechanism is driven to rotate and swing, enabling the human upper arm 10 to implement flexion, extension, abduction, and adduction movements.

Specifically, with reference to FIG. 1 and FIG. 2, when a first revolute drive 31 is applied to the third member 5, the third member 5 rotates around a revolute axis of the first revolute pair 19, the third member 5 rotates to drive the fourth member 6 to rotate, and the fourth member 6 moves relative to the fifth member 7 along an axis of the first cylindrical pair 23, and drives the eighth member 11 to follow the rotation of the fourth member 6. Because the eighth member 11 is connected to the human upper arm 10 through the second fastening pair 26, the eighth member 11 rotates to drive the human upper arm 10 to implement flexion or extension movements around the shoulder joint kinematic pair 15.

When a movement drive 32 is applied to the fourth member 6, the fourth member 6 moves along the axis of the first cylindrical pair 23 and moves within the guide groove of the third member 5. Because this guide groove is equivalent to a revolute pair, a revolute center 30 of this revolute pair is located on a side of the guide groove close to the human upper arm 10. Therefore, when the fourth member 6 moves within the guide groove, the third member 5 rotates around the revolute center 30 and a revolute axis of the third revolute pair 21, thereby causing the fourth member 6 to follow the third member 5 to rotate around the revolute axis of the third revolute pair 21. The fourth member 6 rotates through the first cylindrical pair 23, the fifth member 7, the sixth revolute pair 25, and the eighth member 11, and the eighth member 11 is connected to the human upper arm 10 through the second fastening pair 26. Therefore, the rotation of the fourth member 6 drives the human upper arm 10 to rotate around the shoulder joint kinematic pair 15, thereby implementing abduction or adduction movements of the human upper arm 10.

When the first revolute drive 31 is applied to the third member 5 and the movement drive 32 is applied to the fourth member 6 simultaneously, composite movements of flexion, extension, abduction, and adduction of the human upper arm 10 can be implemented.

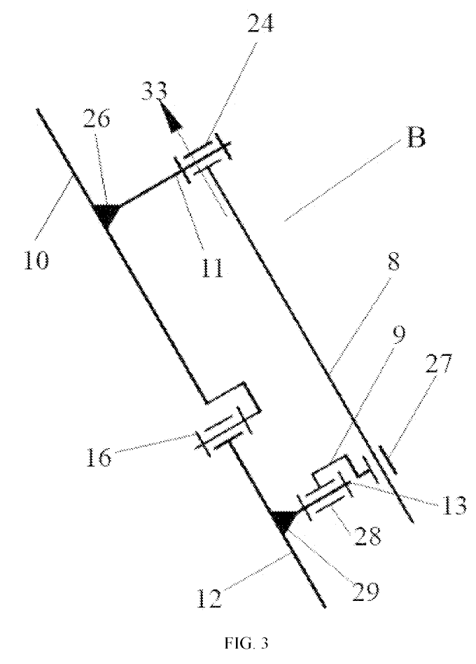

Additionally, with reference to FIG. 1 and FIG. 3, the elbow joint mechanism B includes: the second fastening pair 26, the eighth member 11, the fifth revolute pair 24, the sixth member 8, the second cylindrical pair 27, the seventh member 9, the seventh revolute pair 28, the ninth member 13, and the third fastening pair 29. According to one embodiment of an exoskeleton robot corresponding to the upper limb rehabilitation exoskeleton mechanism of the present invention, the shoulder joint mechanism A and the elbow joint mechanism B may each include the eighth member 11 and the second fastening pair 26, or the shoulder joint mechanism A and the elbow joint mechanism B may share the eighth member 11 and the second fastening pair 26, thereby further integrating and simplifying members, reducing a quantity of members, and helping to reduce the weight of an upper limb rehabilitation exoskeleton device corresponding to the upper limb rehabilitation exoskeleton mechanism.

With reference to FIG. 1 and FIG. 3, one end of the eighth member 11 is connected to the human upper arm 10 through the second fastening pair 26, the other end of the eighth member 11 is connected to the sixth member 8 through the fifth revolute pair 24, the fifth revolute pair 24 is connected to the seventh member 9 through the second cylindrical pair 27, the seventh member 9 is connected to the ninth member 13 through the seventh revolute pair 28, and the ninth member 13 is connected to the human forearm 12 through the third fastening pair 29.

The elbow joint mechanism B provided by the present invention can be connected to the human upper arm 10 through the eighth member 11 by means of the second fastening pair 26, and to the human forearm 12 through the ninth member 13 by means of the third fastening pair 29. In this way, movement of the elbow joint mechanism B drives the human forearm 12 to perform a corresponding movement around the elbow joint kinematic pair 16.

In the elbow joint mechanism B provided by the present invention, in combination with a physiological structure and movement characteristics of the human elbow joint, two revolute pairs (the fifth revolute pair 24 and the elbow joint kinematic pair 16) and a composite kinematic pair formed by the second cylindrical pair 27 and the seventh revolute pair 28 form a planar swing link mechanism. This planar swing link mechanism is driven to swing, enabling the human forearm 12 to implement flexion and extension movements.

Specifically, with reference to FIG. 1 and FIG. 3, when the second revolute drive 33 is applied to the fifth revolute pair 24, the fifth revolute pair 24 rotates around a revolute axis, to drive the sixth member 8 to rotate around a revolute axis of the fifth revolute pair 24. In addition, the sixth member 8 also moves relative to the seventh member 9 through the second cylindrical pair 27. In addition, the rotation of the sixth member 8 drives, through the second cylindrical pair 27, the seventh member 9 and the ninth member 13 to follow the sixth member 8 to rotate around the revolute axis of the fifth revolute pair 24. The ninth member 13 is connected to the human forearm 12 through the third fastening pair 29. Therefore, the rotation of the ninth member 13 drives the human forearm 12 to rotate around the elbow joint kinematic pair 16, thereby implementing flexion or extension movements of the human forearm 12.

When the first revolute drive 31, the movement drive 32, and the second revolute drive 33 are applied simultaneously, composite movements of flexion, extension, abduction, and adduction of the human upper arm 10, and flexion and extension of the human forearm 12 can be implemented, thereby enabling a hand 14, which is connected to the human forearm 12 through the wrist joint kinematic pair 17, to reach a desired position.

In some embodiments, with reference to FIG. 1 to FIG. 3, the shoulder fastening member 2 is vertically fastened to the human shoulder 1 through the first fastening pair 18, and a revolute axis of the first revolute pair 19 is perpendicular to the shoulder fastening member 2. A revolute axis of the sixth revolute pair 25 is perpendicular to an axis of the first cylindrical pair 23, the eighth member 11 is vertically fastened to the human upper arm 10 through the second fastening pair 26, and the axis of the first cylindrical pair 23 is parallel to the human upper arm 10. A revolute axis of the fifth revolute pair 24 is perpendicular to the axis of the first cylindrical pair, a revolute axis of the seventh revolute pair 28 is perpendicular to an axis of the second cylindrical pair 27, the ninth member 13 is vertically fastened to the human forearm 12 through the third fastening pair 29, and the axis of the second cylindrical pair 27 is parallel to the human forearm 12.

The three-degree-of-freedom wearable upper limb rehabilitation exoskeleton mechanism provided by the present invention has the following beneficial effects.

Movements in three degrees of freedom can be implemented, namely, flexion or extension of the human upper arm 10, abduction or adduction of the human upper arm 10, and flexion or extension of the human forearm 12. Further, the movements in three degrees of freedom are combined, so that composite movements of flexion, extension, abduction, and adduction of the human upper arm 10, as well as flexion and extension of the human forearm 12, can be implemented, thereby enabling the hand 14 to reach a desired position.

In the upper limb rehabilitation exoskeleton mechanism provided by the present invention, a small number of members results in lower weight of the corresponding exoskeleton device; and the kinematic pairs are simple and easy to implement, kinematic relationships are simple, and only three drives are required to implement movements in three degrees of freedom, providing more precise movements.

The shoulder joint mechanism A and the shoulder joint kinematic pair 15 form the spatial swing link mechanism, and the elbow joint mechanism B and the elbow joint kinematic pair 16 form the planar swing link mechanism. Therefore, when worn, the kinematic pairs of the upper limb rehabilitation exoskeleton mechanism of the present invention are not required to be aligned with the human joints, solving the problem of joint misalignment when the upper limb rehabilitation exoskeleton mechanism is worn. Moreover, when the human shoulder joints and elbow joints are driven to perform rehabilitation movements, a non-driving force or torque exerted on the human joints in a human-machine closed-chain mechanism increases patient comfort and avoids joint damage during rehabilitation exercises.

When worn, positional accuracy requirements for connection positions of the members connected to the human body are low, facilitating wearing.

A connection position between the first cylindrical pair 23 and the fourth member 6 and a connection position between the second cylindrical pair 27 and the sixth member 8 are adjusted, and the first cylindrical pair 23 and the fourth member 6, and/or the second cylindrical pair 27 and the sixth member 8 are adjusted, so that relative positions of the sixth member 8 and the seventh member 9 can be automatically adjusted, thus implementing adaptive wearing for different patients with variations in upper limb sizes, thereby helping to wear the upper limb exoskeleton mechanism and reducing specifications or models of the upper limb exoskeleton.

The third member 5 and the fourth member 6 are connected by the guide groove equivalent to a revolute pair and a slider structure, which is more suitable for a physiological structure of the human shoulder.

In the wearable shoulder joint rehabilitation exoskeleton mechanism provided by the present invention, the shoulder joint mechanism A and the elbow joint mechanism B can be used separately to perform rehabilitation training for the shoulder joint and elbow joint separately. As described above, the shoulder joint mechanism A provided by the present invention enables the human upper arm 10 to implement flexion, extension, abduction, and adduction movements around the shoulder joint kinematic pair 15, which is beneficial to rehabilitation training for the human shoulder joint. The elbow joint mechanism B provided by the present invention enables the human forearm 12 to implement flexion and extension movements around the elbow joint kinematic pair 16, which is beneficial to rehabilitation training for the human elbow joint.

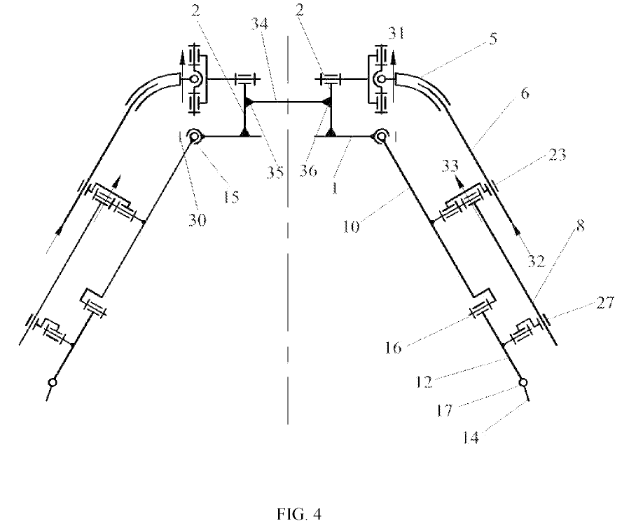

In addition, the three-degree-of-freedom wearable upper limb rehabilitation exoskeleton mechanism provided by the present invention can be used as an assembly. With reference to FIG. 4, the assembly includes two of the aforementioned upper limb rehabilitation exoskeleton mechanisms and the combined member 34 for connecting the two upper limb exoskeleton mechanisms. The two upper limb rehabilitation exoskeleton mechanisms are respectively connected to left and right upper limbs of a human body, and the combined member 34 is connected to the two shoulder fastening members 2 through the fourth fastening pair 35 and the fifth fastening pair 36, respectively. As shown in FIG. 4, the two upper limb rehabilitation exoskeleton mechanisms are respectively connected to the left and right upper limbs of the human body. The combined member 34 is vertically fastened to the shoulder fastening member 2 of one of the upper limb rehabilitation exoskeleton mechanisms through the fourth fastening pair 35, and is vertically fastened to the shoulder fastening member 2 of the other of the upper limb rehabilitation exoskeleton mechanisms through the fifth fastening pair 36.

The preferred embodiments of the present invention have been described in detail above with reference to the accompanying drawings. However, the present invention is not limited thereto. Within the scope of the technical concept of the present invention, various simple modifications can be made to the technical solution of the present invention, including combining various specific technical features in any suitable manner. To avoid unnecessary repetition, the present invention does not describe all possible combinations separately. However, these simple modifications and combinations should also be regarded as content disclosed in the present invention and are all within the scope of protection of the present invention.

What is claimed is:

1. A three-degree-of-freedom wearable upper limb rehabilitation exoskeleton mechanism, comprising:
a shoulder joint mechanism, wherein two ends of the shoulder joint mechanism are fastened to a human shoulder and a human upper arm, respectively, and the shoulder joint mechanism is configured to drive the human upper arm to implement flexion, extension, abduction, and adduction movements; and
an elbow joint mechanism, wherein two ends of the elbow joint mechanism are fastened to the human upper arm and a human forearm, respectively, and the elbow joint mechanism is configured to drive the human forearm to implement flexion and extension movements,
wherein the shoulder joint mechanism comprises: a shoulder fastening member connected to the human shoulder through a first fastening pair; a first member connected to the shoulder fastening member through a first revolute pair; a second member connected to the first member through a second revolute pair and a fourth revolute pair, axes of the second revolute pair and the fourth revolute pair being coaxially arranged; a third member connected to the second member through a third revolute pair, wherein revolute axes of the first revolute pair, the second revolute pair, and the third revolute pair are mutually orthogonal; a fourth member connected to the third member through an arc groove, a revolute center of the arc groove being located on a side of the third member close to the human upper arm; a fifth member connected to the fourth member through a first cylindrical pair; an eighth member connected to the fifth member through a sixth revolute pair, an axis of the first cylindrical pair being orthogonal to a revolute axis of the sixth revolute pair, and the eighth member being connected to the human upper arm through a second fastening pair; and
the elbow joint mechanism comprises: the eighth member connected to the human upper arm through the second fastening pair; a sixth member connected to the eighth member through a fifth revolute pair; a seventh member connected to the sixth member through a second cylindrical pair; a ninth member connected to the seventh member through a seventh revolute pair, an axis of the second cylindrical pair being orthogonal to a revolute axis of the seventh revolute pair, and the ninth member being connected to the human forearm through a third fastening pair;
wherein the eighth member and the human upper arm are vertically fastened to each other through the second fastening pair;
wherein an axis of the fifth revolute pair is perpendicular to an axis of the first cylindrical pair;
wherein the ninth member and the human forearm are vertically fastened to each other through the third fastening pair.
